(19) United States
(12) Patent Application Publication
(10) Pub. No.: US 2012/0236841 A1
(43) Pub. Date: Sep. 20, 2012

(54) BASE STATION APPARATUS FOR TRANSMITTING OR RECEIVING A SIGNAL INCLUDING PREDETERMINED INFORMATION

(75) Inventors: Ken NAKAOKA, Ichinomiya City (JP); Makoto Nagai, Kakamigahara City (JP)

(73) Assignee: SANYO ELECTRIC CO., LTD., Osaka (JP)

(21) Appl. No.: 13/425,146

(22) Filed: Mar. 20, 2012

Related U.S. Application Data
(63) Continuation of application No. PCT/JP2011/002775, filed on May 18, 2011.

(30) Foreign Application Priority Data
May 18, 2010 (JP) 2010-114717
May 18, 2010 (JP) 2010-114718
May 20, 2010 (JP) 2010-116772
May 31, 2010 (JP) 2010-124950

(51) Int. Cl. H04W 88/00; H04J 3/00

(52) U.S. Cl. 370/345

(57) ABSTRACT

A base station apparatus controls inter-terminal communication. Basic information containing information about a first period and extended information containing the information about a second period and a third period are defined and a generation unit generates a packet signal containing an identifier to identify whether the basic information of the basic information and the extended information is contained in the packet signal or the basic information and the extended information are contained in the packet signal. A modem unit and an RF unit broadcast the packet signal containing the identifier generated by the generation unit.

### BACKGROUND OF THE INVENTION

1. Field of the Invention

The present invention relates to communication technology, and in particular, relates to abase station apparatus that transmits or receives a signal including predetermined information.

2. Description of the Related Art

To prevent an intersection collision, road-to-vehicle communication has been discussed. In road-to-vehicle communication, information about circumstances of an intersection is communicated between a road-side apparatus and an on-vehicle apparatus. It is necessary to install a road-side apparatus for road-to-vehicle communication, leading to increased labor and costs.

In inter-vehicle communication, that is, in a form in which information is communicated between on-vehicle apparatuses, by contrast, there is no need to install a road-side apparatus. In that case, the current position information is detected in real time by, for example, GPS (Global Positioning System) and the position information is exchanged between on-vehicle apparatuses to judge on which road leading to the intersection the own vehicle and other vehicle are each positioned.

In wireless LAN (Local Area Network) conforming to standards such as IEEE802.11, an access control function called CSMA/CA (Carrier Sense Multiple Access with Collision Avoidance) is used. Therefore, the same radio channel is shared by a plurality of terminal apparatuses in the wireless LAN. In CSMA/CA, a packet signal is transmitted after making sure that no other packet signal is transmitted by a carrier sense.

When, like ITS (Intelligent Transport Systems), wireless LAN is applied to inter-vehicle communication, on the other hand, it is necessary to transmit information to an unspecified many terminal apparatuses and thus, it is desirable to transmit a signal by broadcasting. However, with an increasing number of vehicles, that is, with an increasing number of terminal apparatuses, an increase in collision of packet signals is assumed due to increased traffic. As a result, data contained in packet signals is not transmitted to other terminal apparatuses. If such a situation arises in inter-vehicle communication, an object of preventing intersection collisions will not be achieved.

The shape of intersection and the traffic volume vary and there are some intersections for which a packet signal should be transmitted immediately before entering the intersection and a packet signal should be transmitted in advance some distance apart from the intersection for others. In the former case, the importance of a packet signal transmitted from a terminal apparatus close to an intersection is higher than the importance of a packet signal transmitted from a terminal apparatus apart from an intersection. In the latter case, on the other hand, the importance of a packet signal transmitted from a terminal apparatus apart from an intersection is higher than the importance of a packet signal transmitted from a terminal apparatus close to an intersection. Thus, setting priorities in accordance with the position from which a packet signal should be transmitted is required. Incidentally, there are some intersections where the number of terminal apparatuses does not increase enormously and simple communication control is desired for such intersections rather than reducing the probability of packet signal collisions. Therefore, implementation of highly flexible inter-vehicle communication is desired. Further, if road-to-vehicle communication is performed in addition to inter-vehicle communication, the communication forms will be diversified. In such a case, the reduction of mutual influence between inter-vehicle communication and road-to-vehicle communication is required.

### SUMMARY OF THE INVENTION

The present invention is made in view of such circumstances and an object thereof is to provide a technology that realizes highly flexible inter-terminal communication.

To solve the above problems, abase station apparatus in an aspect of the present invention is abase station apparatus controlling inter-terminal communication, including a generation unit configured to generate a packet signal containing an identifier to identify that basic information of the basic information and extended information is contained in the packet signal or the basic information and the extended information are contained in the packet signal, wherein the basic information contains information about a first period and the extended information contains the information about a second period and a third period, and a broadcasting unit configured to broadcast the packet signal containing the identifier generated by the generation unit.

Meanwhile, optional combination of the above-described components and those obtained by converting representation of the present invention among a method, an apparatus, a system, a recording medium, and a computer program also are effective as an aspect of the present invention.

### BRIEF DESCRIPTION OF THE DRAWINGS

Embodiments will now be described, byway of example only, with reference to the accompanying drawings which are meant to be exemplary, not limiting, and wherein like elements are numbered alike in several Figures, in which:

FIG. 1 is a diagram showing a configuration of a communication system according to an embodiment of the present invention;

FIG. 2 is a diagram showing the configuration of a base station apparatus in FIG. 1;

FIGS. 3A to 3D are diagrams showing a format of a frame defined for the communication system in FIG. 1;

FIGS. 4A and 4B are diagrams illustrating the configuration of a priority area and a general area;

FIGS. 5A and 5B are diagrams showing the configuration of subframes in FIGS. 3A to 3D;

FIGS. 6A and 6B are diagrams showing the format of a MAC frame defined for the communication system in FIG. 1 and stored in a packet signal;

FIG. 7 is a diagram showing the configuration of a terminal apparatus mounted on a vehicle in FIG. 1;

FIG. 8 is a flow chart showing a procedure for setting a priority area identifier in the base station apparatus in FIG. 3;

FIG. 9 is a flow chart showing the procedure for selecting a priority period or a general period in the terminal apparatus in FIG. 7;

FIG. 10 is a diagram showing the configuration of the communication system according to a modification of the present invention;

FIG. 11 is a diagram showing another configuration of the communication system according to the modification of the present invention;

FIG. 12 is a diagram showing the configuration of the base station apparatus in FIGS. 10 and 11;

FIGS. 13A to 13D are diagrams showing the format of the frame defined for the communication system in FIGS. 10 and 11;

FIGS. 14A and 14B are diagrams showing the configuration of the subframes in FIGS. 13A to 13D;

FIGS. 15A to 15C are diagrams showing the format of the MAC frame defined for the communication system in FIGS. 10 and 11 and stored in the packet signal;

FIGS. 16A and 16B are diagrams showing another configuration of the subframes in FIGS. 13A to 13D;

FIG. 17 is a diagram showing the configuration of the terminal apparatus mounted on the vehicle in FIGS. 10 and 11;

FIG. 18 is a flow chart showing the procedure for generating a message header in the base station apparatus in FIG. 12;

FIG. 19 is a flow chart showing the procedure for inserting the message header in the base station apparatus in FIG. 12;

FIG. 20 is a flow chart showing the procedure for inserting the message header in the base station apparatus according to another modification of the present invention; and

FIGS. 21A to 21G are diagrams showing the format of the frame defined for the communication system according to still another modification of the present invention.

### DETAILED DESCRIPTION OF THE INVENTION

The invention will now be described by reference to the preferred embodiments. This does not intend to limit the scope of the present invention, but to exemplify the invention.

Before specifically describing the present invention, an overview will be provided. An embodiment of the present invention relates to a communication system that performs inter-vehicle communication between terminal apparatuses mounted on vehicles and also performs road-to-vehicle communication from a base station apparatus installed at an intersection or the like to a terminal apparatus. In the inter-vehicle communication, a terminal apparatus transmits a packet signal in which information such as the speed and position of a vehicle (hereinafter, called “data”) is stored by broadcasting. Other terminal apparatuses receive the packet signal and recognize an approaching vehicle or the like based on the data. The base station apparatus defines a frame containing a plurality of subframes repeatedly. The base station apparatus selects one of the plurality of subframes for road-to-vehicle communication and transmits a packet signal in which control information or the like is stored in a period of the leading portion of the selected subframe by broadcasting.

The control information contains information about a period (hereinafter, called a “road-to-vehicle transmission period”) in which the base station apparatus transmits a packet signal by broadcasting. The terminal apparatus identifies the road-to-vehicle transmission period based on the control information and transmits a packet signal in a period other than the road-to-vehicle transmission period. Thus, road-to-vehicle communication and inter-vehicle communication are time-division multiplexed and so the probability of collision of packet signals of both types of communication is reduced. That is, interference between road-to-vehicle communication and inter-vehicle communication is reduced by content of control information being recognized by the terminal apparatus. The area in which the terminal apparatus performing inter-vehicle communication is present can roughly be divided into three types of area.

One type of area is an area formed around a base station apparatus (hereinafter, called a “first area”), another type of area is an area (hereinafter, called a “second area”) formed outside the first area, and still another type of area is an area (hereinafter, called “outside the second area”) formed outside the second area. While a packet signal from the base station apparatus can be received by a terminal apparatus in a certain level of quality in the first area and the second area, a packet signal from the base station apparatus cannot be received by a terminal apparatus in a certain level of quality outside the second area. The first area is formed closer to the center of an intersection than the second area. The following two situations can be assumed depending on the shape of an intersection. The first situation is a case when a vehicle present in the second area is approaching the intersection and a packet signal from the terminal apparatus mounted on the vehicle is important information from the viewpoint of suppressing a collision. The second situation is a case when a vehicle present in the first area is present close to an intersection and a packet signal from the terminal apparatus mounted on the vehicle is important information from the viewpoint of suppressing a collision.

Corresponding to such area definitions, a period (hereinafter, called a “inter-vehicle transmission period”) for inter-vehicle communication is formed by time-division multiplexing of a priority period and a general period. The priority period is formed from a plurality of slots and the terminal apparatus broadcasts a packet signal in one of the plurality of slots. The general period has a predetermined period and the terminal apparatus broadcasts a packet signal by the CSMA method in the general period. A terminal apparatus present outside the second area transmits a packet signal by the CSMA method regardless of the frame configuration. In the first situation described above, a terminal apparatus present in the second area is allowed to use a priority period and a terminal apparatus present in the first area is allowed to use a general period. In the second situation described above, a terminal apparatus present in the first area is allowed to use a priority period and a terminal apparatus present in the second area is allowed to use a general period. Here, in which area the terminal apparatus mounted on a vehicle is present is determined. Incidentally, some base station apparatuses have no first area formed therearound. In such a case, the inter-vehicle transmission period contains no priority period and is formed of general periods only.

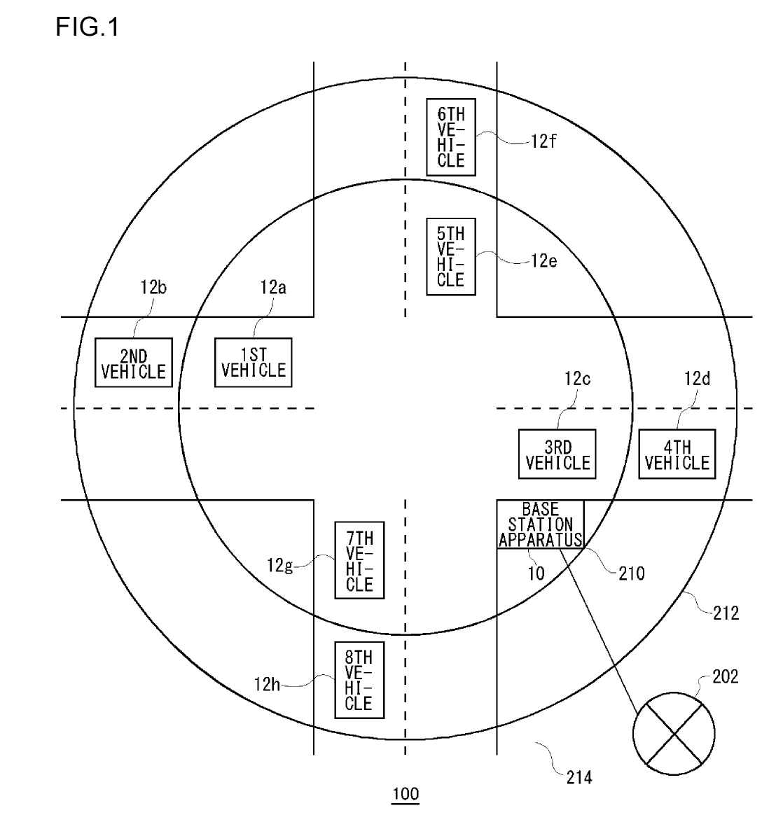

FIG. 1 shows the configuration of a communication system 100 according to an embodiment of the present invention. This corresponds to a case when one intersection is seen from above. The communication system 100 includes a base station apparatus 10, a first vehicle 12a, a second vehicle 12b, a third vehicle 12c, a fourth vehicle 12d, a fifth vehicle 12e, a sixth vehicle 12f, a seventh vehicle 12g, and an eighth vehicle 12h, which are collectively referred to as vehicles 12, and a network 202. A terminal apparatus (not shown) is mounted on each of the vehicles 12. A first area 210 is formed around the base station apparatus 10, a second area 212 is formed outside the first area 210, and an area outside second area 214 is formed outside the second area 212.

As shown in FIG. 1, a road in a horizontal direction, that is, in a right-left direction of the drawing and a road in a vertical direction, that is, in an up-down direction of the drawing intersect with each other in a central portion. Herein, an upper side of the drawing corresponds to the “north”, a left side thereof corresponds to the “west”, a lower side thereof corresponds to the “south”, and a right side thereof corresponds to the “east”. Also, a portion in which the two roads intersect with each other is the “intersection”. The first and second vehicles 12a and 12b travel from left to right and the third and fourth vehicles 12c and 12d travel from right to left. Also, the fifth and sixth vehicles 12e and 12f travel downward from above and the seventh and eighth vehicles 12g and 12h travel upward from below.

In the communication system 100, the base station apparatus 10 is arranged at an intersection. The base station apparatus 10 controls communication between terminal apparatuses. The base station apparatus 10 repeatedly generates a frame containing a plurality of subframes based on a signal received from a GPS satellite (not shown) or frames generated by the other base station apparatuses 10. A road-to-vehicle transmission period is allowed to be set to the leading portion of each subframe. The base station apparatus 10 selects a subframe to which no road-to-vehicle period is set by another base station apparatus 10 from the plurality of subframes. The base station apparatus 10 sets a road-to-vehicle transmission period to the leading portion of the selected subframe. The base station apparatus 10 broadcasts a packet signal in the set road-to-vehicle transmission period.

A plurality of types of data can be assumed as data to be contained in a packet signal. One type of data is data such as traffic j am information and construction information and another type of data is data on each slot contained in the priority period. The latter contains slots (hereinafter, called “vacant slots”) used by none of terminal apparatuses, slots (hereinafter, called “used slots”) used by one terminal apparatus, and slots (hereinafter, called “collision slots”) used by a plurality of terminal apparatuses. A packet signal (hereinafter, called an “RSU packet signal”) containing data such as traffic jam information and construction information and a packet signal (hereinafter, called a “control packet signal”) containing data on each slot are generated separately. The RSU packet signal and the control packet signal are generically called a “packet signal”.

The first area 210 and the second area 212 are formed around the communication system 100 in accordance with receiving conditions when a terminal apparatus receives a packet signal from the base station apparatus 10. As shown in FIG. 1, the first area 210 is formed close to the base station apparatus 10 as an area in which receiving conditions are relatively good. The first area 210 can be said to be formed close to the central portion of the intersection. Outside the first area 210, on the other hand, the second area 212 is formed as an area in which receiving conditions are worse than in the first area 210. Further, outside the second area 212, the area outside second area 214 is formed as an area in which receiving conditions are further worse than in the second area 212. As receiving conditions, the error rate of a packet signal or received power is used.

Two types of control information are contained in a packet signal from the base station apparatus 10. One type is information (hereinafter, called a “basic part”) about the set road-to-vehicle transmission period and the other type is information (hereinafter, called an “extension part”) about the set priority period. The terminal apparatus generates a frame based on the basic part contained in a received packet signal. As a result, a frame generated by each of the plurality of terminal apparatuses is synchronized with a frame generated by the base station apparatus 10. The terminal apparatus receives a packet signal broadcasted by the base station apparatus 10 and estimates in which of the first area 210, the second area 212, and the area outside second area 214 the terminal apparatus is present based on receiving conditions of the received packet signal and the extension part.

Further, the extension part contained in the packet signal from the base station apparatus 10 contains information (hereinafter, called a “priority area identifier”) indicating the correspondence between the area and the inter-vehicle transmission period. The information indicating the correspondence between the area and the inter-vehicle transmission period can be said to be information indicating in which of the first area 210 and the second area 212 the priority period should be used. A first arrangement and a second arrangement are defined and the general period is used in the first area 210 and the priority period is used in the second area 212 in the first arrangement. On the other hand, the priority period is used in the first area 210 and the general period is used in the second area 212 in the second arrangement. When the priority area identifier indicates the first arrangement, the terminal apparatus broadcasts a packet signal by a carrier sense in a general period if the terminal apparatus is present in the first area 210 and broadcasts a packet signal in one of slots contained in a priority period if the terminal apparatus is present in the second area 212. When the priority area identifier indicates the second arrangement, the terminal apparatus broadcasts a packet signal in one of slots contained in a priority period if the terminal apparatus is present in the first area 210 and broadcasts a packet signal by a carrier sense in a general period if the terminal apparatus is present in the second area 212.

As a result, TDMA is executed in the priority period and CSMA/CA is executed in the general period. The terminal apparatus selects a subframe of the same relative timing also in the next frame. Particularly in the priority period, the terminal apparatus selects a slot of the same relative timing in the next frame. The terminal apparatus acquires data and stores the data in a packet signal. The data includes information about the position of presence. The terminal apparatus also stores control information in a packet signal. That is, control information transmitted from the base station apparatus 10 is transferred by the terminal apparatus. If the terminal apparatus estimates to be present in the area outside second area 214, the terminal apparatus broadcasts a packet signal by executing CSMA/CA regardless of the frame configuration.

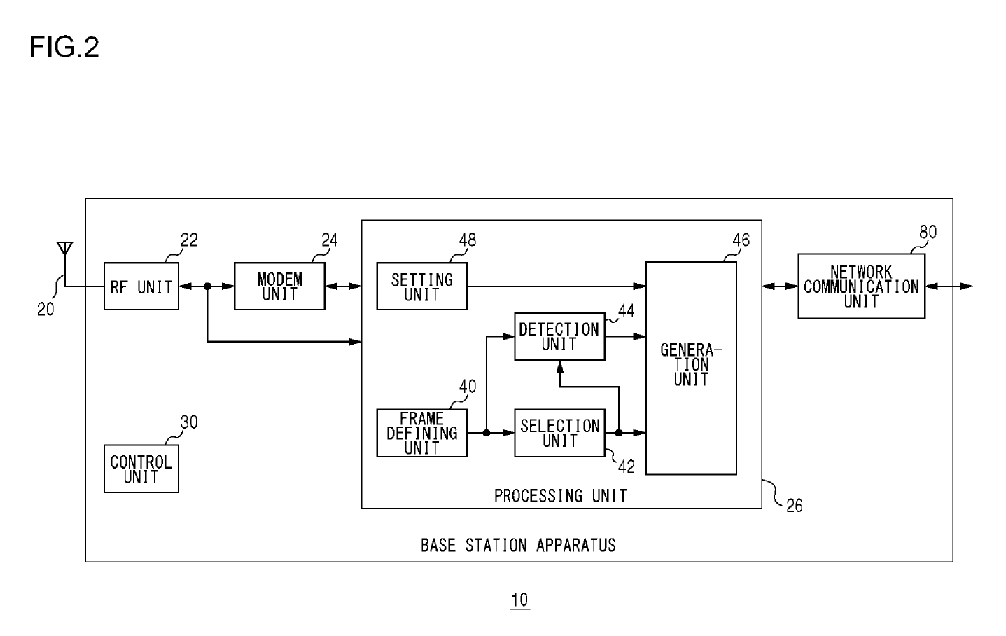

FIG. 2 shows the configuration of the base station apparatus 10. The base station apparatus 10 includes an antenna 20, an RF unit 22, a modem unit 24, a processing unit 26, a control unit 30, and a network communication unit 80. The processing unit 26 includes a frame defining unit 40, a selection unit 42, a detection unit 44, a generation unit 46, and a setting unit 48. The RF unit 22 receives a packet signal from terminal apparatuses or the other base station apparatuses 10 (not shown) through the antenna 20 as receiving processing. The RF unit 22 generates a baseband packet signal by making a frequency conversion of the received packet signal at radio frequency. Further, the RF unit 22 outputs the baseband packet signal to the modem unit 24. In general, the baseband packet signal is formed of an in-phase component and an quadrature component, so that two signal lines should be indicated; however, only one signal line is herein indicated to make the drawing clear. The RF unit 22 also includes an LNA (Low Noise Amplifier), mixer, AGC, and A/D conversion unit.

The RF unit 22 generates a packet signal at radio frequency by making a frequency conversion of a baseband packet signal input from the modem unit 24 as transmission processing. Further, the RF unit 22 transmits a packet signal at radio frequency from the antenna 20 in a road-to-vehicle transmission period. The RF unit 22 also includes a PA (Power Amplifier), mixer, and A/D conversion unit.

The modem unit 24 performs demodulation of a baseband packet signal from the RF unit 22 as receiving processing. Further, the modem unit 24 outputs a demodulation result to the processing unit 26. The modem unit 24 also performs demodulation of data from the processing unit 26 as transmission processing. Further, the modem unit 24 outputs the demodulation result to the RF unit 22 as a baseband packet signal. The communication system 100 supports the OFDM (Orthogonal Frequency Division Multiplexing) modulation method and thus, the modem unit 24 also performs FFT (Fast Fourier Transform) as receiving processing and also performs IFFT (Inverse Fast Fourier Transform) as transmission processing.

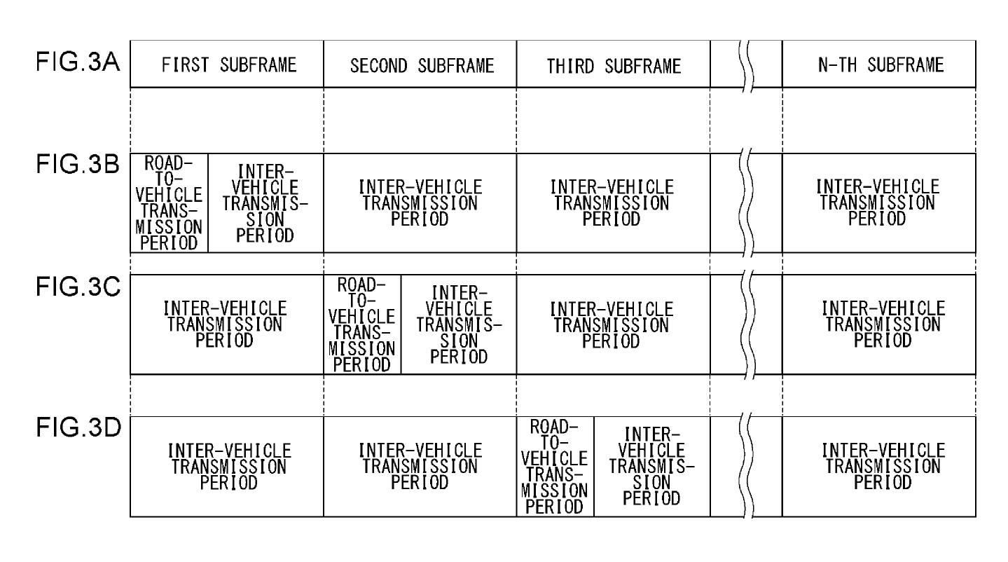

The frame defining unit 40 receives a signal from a GPS satellite (not shown) and acquires time information based on the received signal. A publicly known technology may be used to acquire time information, so that the description thereof is herein omitted. The frame defining unit 40 generates a plurality of frames based on time information. For example, the frame defining unit 40 generates 10 frames of “100 msec” by dividing a “1 sec” period into 10 frames relative to the timing indicated by time information. Frames are defined to be repeated by repeating the above processing. The frame defining unit 40 may generate frames based on control information detected from a demodulation result. Such processing corresponds to generation of frames synchronized with the timing of frames generated by the other base station apparatus 10. FIGS. 3A to 3D show a format of a frame defined for the communication system 100. FIG. 3A shows a frame configuration. The frame is formed of N subframes indicated by a first subframe to an N-th subframe. If, for example, the frame length is 100 msec and N is 8, subframes of the length of 12.5 msec are defined. FIGS. 3B to 3D will be described later to return to FIG. 2.

The selection unit 42 selects a subframe to which a road-to-vehicle transmission period should be set from a plurality of subframes contained in the frame. More specifically, the selection unit 42 receives a frame defined by the frame defining unit 40. The selection unit 42 has a demodulation result from the other base station apparatuses 10 or terminal apparatuses (not shown) input thereinto via the RF unit 22 and the modem unit 24. The selection unit 42 extracts a demodulation result from the base station apparatus 10 from among the input demodulation results. The extraction method will be described later. The selection unit 42 identifies subframes from which no demodulation result is received by identifying subframes from which demodulation results have been received. This corresponds to identification of subframes to which no road-to-vehicle transmission period by the other base station apparatus 10 is set, that is, unused subframes. If a plurality of unused subframes is present, the selection unit 42 randomly selects one subframe. If no unused subframe is present, that is, each of the plurality of subframes is used, the selection unit 42 acquires received power corresponding to the demodulation result and selects a subframe of small received power preferentially.

FIG. 3B shows a frame configuration generated by a first base station apparatus 10a. The first base station apparatus 10a sets a road-to-vehicle transmission period to the leading portion of the first subframe. The first base station apparatus 10a also sets an inter-vehicle transmission period subsequent to the road-to-vehicle transmission period in the first subframe. The inter-vehicle transmission period is a period in which the terminal apparatus can broadcast a packet signal. That is, the first base station apparatus 10a is allowed to broadcast a packet signal in the road-to-vehicle transmission period, which is a leading period of the first subframe, and terminal apparatuses are allowed to broadcast a packet signal in the inter-vehicle transmission period other than the road-to-vehicle transmission period of the frame. Further, the first base station apparatus 10a sets only the inter-vehicle transmission period to the second subframe to the N-th subframe.

FIG. 3C shows a frame configuration generated by a second base station apparatus 10b. The second base station apparatus 10b sets the road-to-vehicle transmission period to the leading portion of the second subframe. The second base station apparatus 10b also sets the inter-vehicle transmission period subsequent to the road-to-vehicle transmission period in the second subframe, to the first subframe and the third subframe to the N-th subframe. FIG. 3D shows a frame configuration generated by a third base station apparatus 10c. The third base station apparatus 10c sets the road-to-vehicle transmission period to the leading portion of the third subframe. The third base station apparatus 10c also sets the inter-vehicle transmission period subsequent to the road-to-vehicle transmission period in the third subframe, to the first subframe, the second subframe, and the fourth subframe to the N-the subframe. In this manner, a plurality of the base station apparatuses 10 selects mutually different subframes and sets the road-to-vehicle transmission period to the leading portion of the selected subframe. FIG. 2 is referred to again. The selection unit 42 outputs the number of the selected subframe to the detection unit 44 and the generation unit 46.

The setting unit 48 has an interface to receive instructions from an operator and receives setting instructions of parameters via the interface. For example, the interface is a button and the setting unit 48 receives setting instructions of parameters through input to the button. The interface may also be a connection terminal to the network communication unit 80 described later. At this point, the setting unit 48 receives setting instructions of parameters via the network communication unit 80, the network 202 (not shown), and a PC. Setting instructions of parameters concern whether to use the first arrangement or the second arrangement. The setting unit 48 outputs the received setting instructions to the generation unit 46.

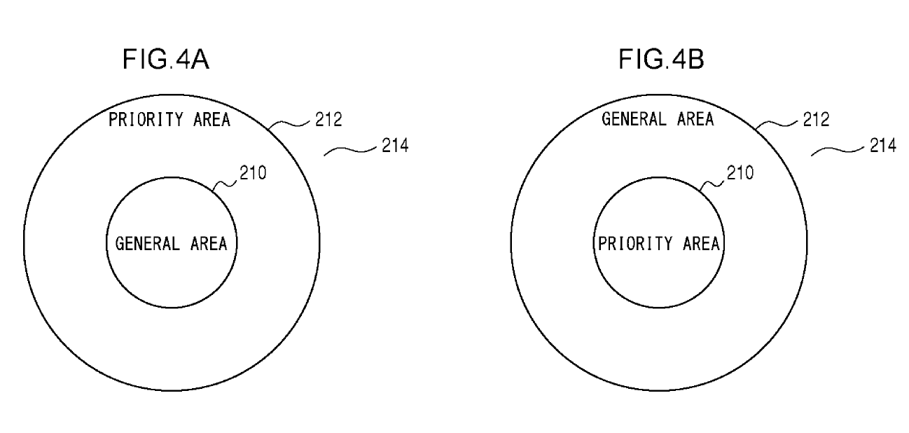

FIGS. 4A and 4B are diagrams illustrating the configuration of a priority area and a general area. The first area 210, the second area 212, and the area outside second area 214 are similar to such areas in FIG. 1. FIG. 4A corresponds to the first arrangement. The first area 210 around the base station apparatus 10 (not shown) is set to a general area. The general area is an area that should use a general period. Thus, a terminal apparatus 14 present in the general area can broadcast a packet signal in a general period. The second area surrounding the first area 210 is set to a priority area. The priority area is an area that should use a priority period. Thus, the terminal apparatus 14 present in the priority area can broadcast a packet signal in each slot forming a priority period. FIG. 4B corresponds to the second arrangement. The first area 210 is set to the priority period and the second area 212 is set to the general period. In the first arrangement and the second arrangement, the sizes of the first area 210 and the second area 212 may be different. FIG. 2 is referred to again.

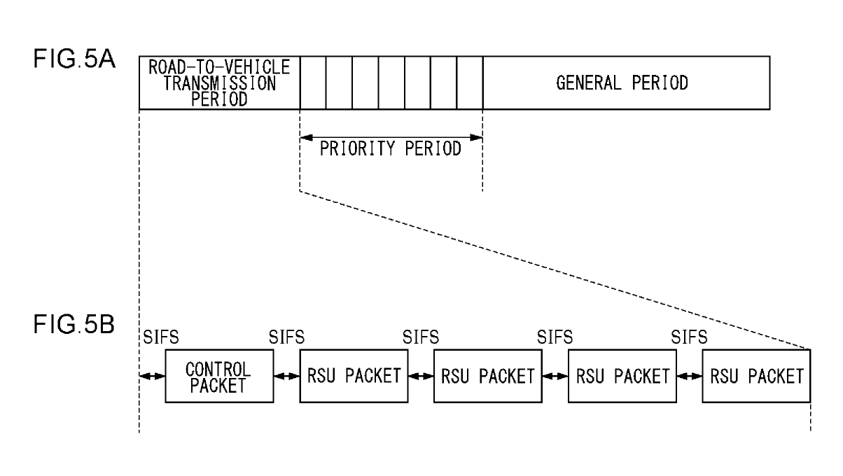

The detection unit 44 identifies whether each of a plurality of slots contained in the priority period is unused, in use, or collided. Before describing processing by the detection unit 44, the configuration of a subframe will be described. FIGS. 5A and 5B show the configuration of a subframe. As shown in FIG. 5A, one subframe is configured in the order of the road-to-vehicle transmission period, priority period, and general period. The base station apparatus 10 broadcasts a packet signal in the road-to-vehicle transmission period, the priority period is formed by time-division multiplexing of a plurality of slots and the terminal apparatus 14 can broadcast a packet signal in each slot, and the general period has a predetermined length and in which the terminal apparatus 14 can broadcast a packet signal. The priority period and the general period correspond to the inter-vehicle transmission period in FIG. 3B and the like. If the subframe contains no road-to-vehicle transmission period, the subframe is configured in the order of the priority period and general period. In this case, the road-to-vehicle transmission period is also a priority period. FIG. 5B will be described later. FIG. 3 is referred to again.

The detection unit 44 measures received power for each slot and also measures the error rate for each slot. An example of the error rate is BER (Bit Error Rate). If received power is smaller than a received power threshold, the detection unit 44 judges that the slot is unused (hereinafter, such a slot will be called a “vacant slot”). On the other hand, if received power is equal to or larger than the received power threshold and the error rate is smaller than an error rate threshold, the detection unit 44 judges that the slot is in use (hereinafter, such a slot will be called a “used slot”). If received power is equal to or larger than the received power threshold and the error rate is equal to or larger than the error rate threshold, the detection unit 44 judges that a collision has occurred in the slot (hereinafter, such a slot will be called a “collided slot”). The detection unit 44 performs such processing on all slots and outputs results thereof (hereinafter, called “detection results”) to the generation unit 46.

The generation unit 46 receives setting instructions from the setting unit 48, the subframe number from the selection unit 42, and detection results from the detection unit 44. The generation unit 46 sets a road-to-vehicle transmission period to the subframe of the received subframe number and generates control packet signals and RSU packet signals to be broadcasted in the road-to-vehicle transmission period. FIG. 5B shows the arrangement of packet signals in the road-to-vehicle transmission period. As shown in FIG. 5B, one control packet signal and a plurality of RSU packet signals are placed in the road-to-vehicle transmission period. Previous and subsequent packet signals are separated by SIFS (Short Interframe Space). FIG. 2 is referred to again.

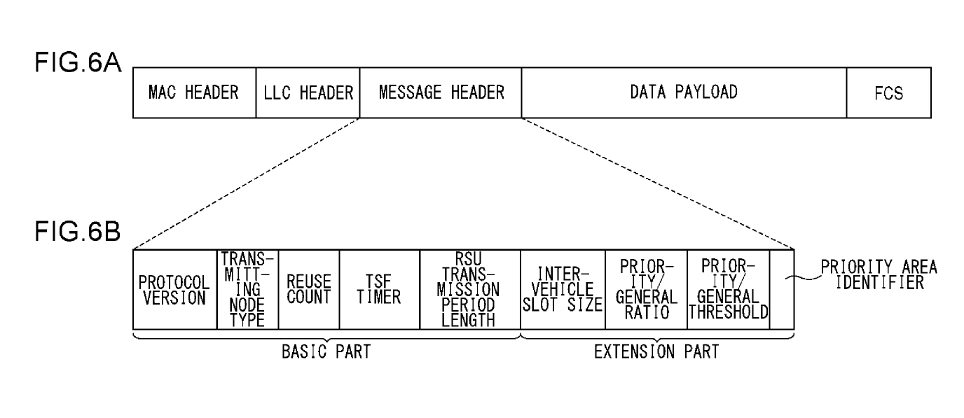

Here, the configurations of a control packet signal and an RSU packet signal will be described. FIGS. 6A and 6B show the format of a MAC frame defined for the communication system 100 and stored in a packet signal. FIG. 6A shows the format of a MAC frame. In the MAC frame, a “MAC header”, “LLC header”, “message header”, “data payload”, and “FCS” are arranged in this order from the head thereof. If detection results are contained in the payload, a packet signal in which the MAC frame is stored corresponds to a control packet signal. If data such as traffic jam information and construction information is received from the network communication unit 80, the generation unit 46 includes such information in the payload. A packet signal in which such a MAC frame is stored corresponds to an RSU packet signal. The network communication unit 80 is connected to the network 202 (not shown). Packet signals broadcasted in the priority period and the general period also store the MAC frame shown in FIG. 6A.

FIG. 6B is a diagram showing the configuration of a message header generated by the generation unit 46. The message header contains the basic part and the extension part. The control packet signal and the RSU packet signal have, as described above, the same configuration and thus, the basic part and the extension part are contained in these packet signals. The basic part contains a “protocol version”, “transmitting node type”, “reuse count”, “TSF timer”, and “RSU transmission period length” and the extension part contains a “inter-vehicle slot size”, “priority/general ratio”, “priority/general threshold”, and “priority area identifier”.

The protocol version shows the version of the corresponding protocol. The transmitting node type shows the transmission source of a packet signal containing the MAC frame. For example, “0” indicates a terminal apparatus and “1” indicates the base station apparatus 10. If the selection unit 42 extracts demodulation results of the other base station apparatuses 10 from input demodulation results, the selection unit 42 uses the value of the transmitting node type. The reuse count shows an indicator of validity when the message header is transferred to terminal apparatuses and the TSF timer shows the transmission time. The RSU transmission period length shows the length of a road-to-vehicle transmission period and is information relating to the road-to-vehicle transmission period.

The inter-vehicle slot size shows the size of a slot contained in the priority period, the priority/general ratio shows the ratio of the priority period to the general period, and the priority/general threshold is a threshold to cause the terminal apparatus 14 to select the use of the priority period or the use of the general period and also a threshold for received power. The priority area identifier is an identifier to indicate the use of the first arrangement or the second arrangement. If the first arrangement is used, that is, the arrangement in FIG. 4A is used, the priority area identifier is set to “0”. If the second arrangement is used, that is, the arrangement in FIG. 4B is used, the priority area identifier is set to “1”. Thus, the extension part corresponds to information relating to the priority period and the general period. FIG. 2 is referred to again.

The processing unit 26 causes the modem unit 24 and the RF unit 22 to transmit packet signals by broadcasting in the road-to-vehicle transmission period. That is, the processing unit 26 broadcasts control packet signals and RSU packet signals containing the basic part and the extension part in base station broadcasting period. The control unit 30 controls processing of the whole base station apparatus 10.

Although this configuration may be realized by a CPU, memory, and another LSI of an optional computer in a hardware aspect and is realized by a program loaded on the memory and the like in a software aspect, a functional block realized by combining these aspects is herein described. Therefore, one skilled in the art may comprehend that these functional blocks may be realized in various modes only by hardware, or only by software, or combination thereof.

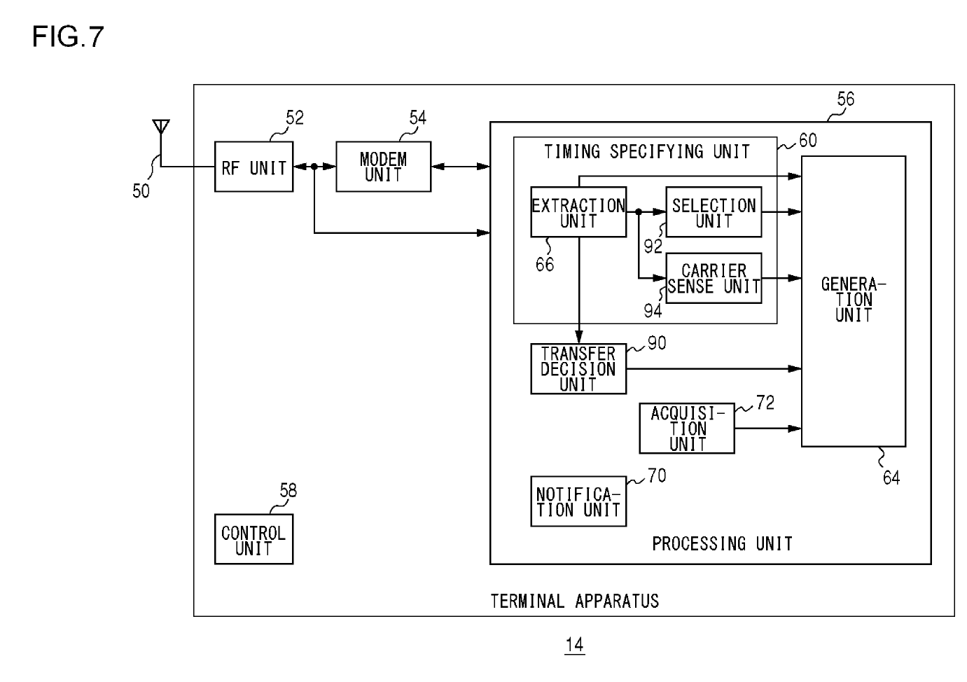

FIG. 7 shows the configuration of the terminal apparatus 14 mounted on the vehicle 12. The terminal apparatus 14 includes an antenna 50, an RF unit 52, a modem unit 54, a processing unit 56, and a control unit 58. The processing unit 56 includes a generation unit 64, a timing specifying unit 60, a transfer decision unit 90, a notification unit 70, and an acquisition unit 72. The timing specifying unit 60 includes an extraction unit 66, a selection unit 92, and a carrier sense unit 94. The antenna 50, the RF unit 52, and the modem unit 54 perform processing similar to processing of the antenna 20, the RF unit 22, and the modem unit 24 in FIG. 2. Thus, the description herein focuses on differences.

The modem unit 54 and the processing unit 56 receive packet signals from the other terminal apparatuses 14 and the base station apparatus 10 (not shown). As described above, the modem unit 54 and the processing unit 56 receive packet signals from the base station apparatus 10 in the road-to-vehicle transmission period. As described above, the modem unit 54 and the processing unit 56 receive packet signals from the other terminal apparatuses 14 in the priority period and general period.

If a demodulation result from the modem unit 54 is a packet signal from the base station apparatus 10 (not shown), the extraction unit 66 identifies the timing of the subframe in which the road-to-vehicle transmission period is arranged. The extraction unit 66 generates a frame based on the subframe timing and content of the basic part in the message header of the packet signal, more specifically, content of the RSU transmission period length. The frame may be generated in the same manner as the frame defining unit 40, so that the description thereof is herein omitted. As a result, the extraction unit 66 generates a frame synchronized with a frame generated by the base station apparatus 10.

The extraction unit 66 measures received power of a packet signal from the base station apparatus 10. Based on the measured received power, the extraction unit 66 estimates to be present in the first area 210, the second area 212, or the area outside second area 214. For example, the extraction unit 66 stores an area judgment threshold. The area judgment threshold corresponds to the above priority/general threshold. If the received power is larger than the area judgment threshold, the extraction unit 66 decides to be present in the first area 210. If the received power is equal to or smaller than the area judgment threshold, the extraction unit 66 decides to be present in the second area 212. If no packet signal from the base station apparatus 10 is received, the extraction unit 66 decides to be present outside the second area 212. Instead of the received power, the extraction unit 66 may use the error rate or a combination of the received power and the error rate.

The extraction unit 66 decides whether the area in which the extraction unit 66 is present is a priority area or a general area based on an estimation result and the priority area identifier. When the priority area identifier is “1”, the extraction unit 66 selects the priority area if present in the first area 210 and the general area if present in the second area 212. When the priority area identifier is “0”, on the other hand, the extraction unit 66 selects the general area if present in the first area 210 and the priority area if present in the second area 212.

Further, if the extraction unit 66 estimates to be in the area outside second area 214, the extraction unit 66 selects timing independent of the frame configuration. If the extraction unit 66 selects a general area, the extraction unit 66 selects a general period. If the extraction unit 66 selects a priority area, the extraction unit 66 selects a priority period. If the extraction unit 66 selects a priority area, the extraction unit 66 outputs detection results contained in the payload of a control packet signal to the selection unit 92. If the extraction unit 66 selects a general area, the extraction unit 66 outputs the timing of the frame and subframes and information about the inter-vehicle transmission period to the carrier sense unit 94. If the extraction unit 66 selects timing independent of the frame configuration, the extraction unit 66 instructs the carrier sense unit 94 to perform a carrier sense.

The selection unit 92 receives detection results from the extraction unit 66. Detection results show, as described above, whether each of a plurality of slots contained in the priority period is a vacant slot, used slot, or collided slot. The selection unit 92 selects one of vacant slots. If a slot is already selected and the slot is a used slot, the selection unit 92 uses the same slot as before. On the other hand, if a slot is already selected and the slot is a collided slot, the selection unit 92 newly selects a vacant slot. The selection unit 92 notifies the generation unit 64 of information about the selected slot as transmission timing.

The carrier sense unit 94 receives the timing of the frame and subframes and information about the inter-vehicle transmission period from the extraction unit 66. The carrier sense unit 94 measures interference power by performing a carrier sense in a general period. The carrier sense unit 94 also decides transmission timing in the general period based on interference power. More specifically, the carrier sense unit 94 stores a predetermined threshold in advance and compared the interference power with the threshold. If the interference power is smaller than the threshold, the carrier sense unit 94 decides the transmission timing. If the carrier sense unit 94 is instructed by the extraction unit 66 to perform a carrier sense, the carrier sense unit 94 decides the transmission timing by executing CSMA without consideration of the frame configuration. The carrier sense unit 94 notifies the generation unit 64 of the decided transmission timing.

The acquisition unit 72 includes a GPS receiver, gyroscope, speed sensor (not shown) and the like and the position of presence, traveling direction, traveling speed and the like (hereinafter, generically called “position information”) of the vehicle 12 (not shown), that is, the vehicle 12 on which the terminal apparatus 14 is mounted are acquired from data supplied from the above components included in the acquisition unit 72. Incidentally, the position of presence is indicated by latitude and longitude. The well-known technology may be used to acquire them, so that the description thereof is herein omitted. The acquisition unit 72 outputs position information to the generation unit 64.

The transfer decision unit 90 controls transfer of the message header. The transfer decision unit 90 extracts the message header from a packet signal. If a packet signal is directly transmitted from the base station apparatus 10, the reuse count is set to “0”, but if a packet signal is transmitted from the other terminal apparatus 14, the reuse count is set to a value of “1 or greater”. The transfer decision unit 90 selects the message header to be transferred from extracted message headers. For example, the message header of the smallest reuse count is selected. The transfer decision unit 90 may also generate a new message header by combining content contained in a plurality of message headers. The transfer decision unit 90 outputs the message header to be selected to the generation unit 64. At this point, the transfer decision unit 90 increments the reuse count by “1”.

The generation unit 64 receives position information from the acquisition unit 72 and a message header from the transfer decision unit 90. The generation unit 64 stores the position information in the payload by using the MAC frame shown in FIGS. 6A and 6B. The generation unit 64 generates a packet signal containing the MAC frame and also transmits the generated packet signal by broadcasting in the transmission timing decided by the selection unit 92 or the carrier sense unit 94 via the modem unit 54, the RF unit 52, and the antenna 50. Incidentally, the transmission timing is contained in the inter-vehicle transmission period.

The notification unit 70 acquires a packet signal from the base station apparatus 10 (not shown) in a road-to-vehicle transmission period and also acquires packet signals from the other terminal apparatuses 14 (not shown) in an inter-vehicle transmission period. As processing on the acquired packet signal, the notification unit 70 notifies the driver of the approaching vehicle 12 (not shown) in accordance with content of data stored in the packet signal via a monitor or speaker. The control unit 58 controls the operation of the whole terminal apparatus 14.

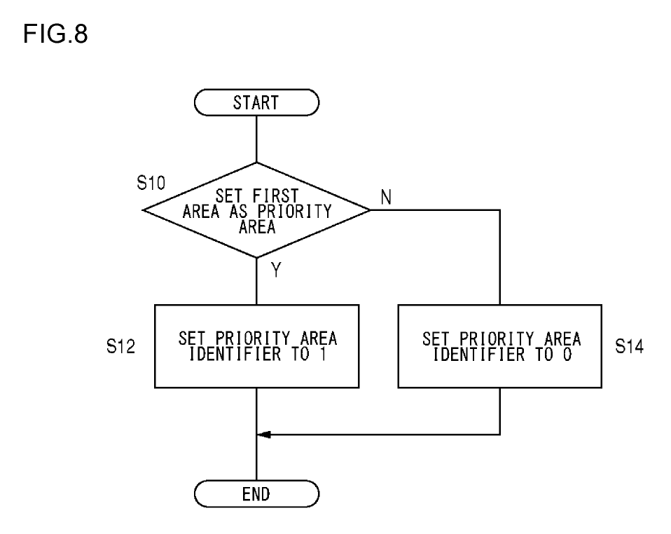

The operation of the communication system 100 in the above configuration will be described. FIG. 8 is a flow chart showing a procedure for setting the priority area identifier in the base station apparatus 10. If the first area 210 is set as the priority area (Y in S10), the generation unit 46 sets the priority area identifier to “1” (S12). On the other hand, if the first area 210 is not set as the priority area (N in S10), the generation unit 46 sets the priority area identifier to “0” (S14).

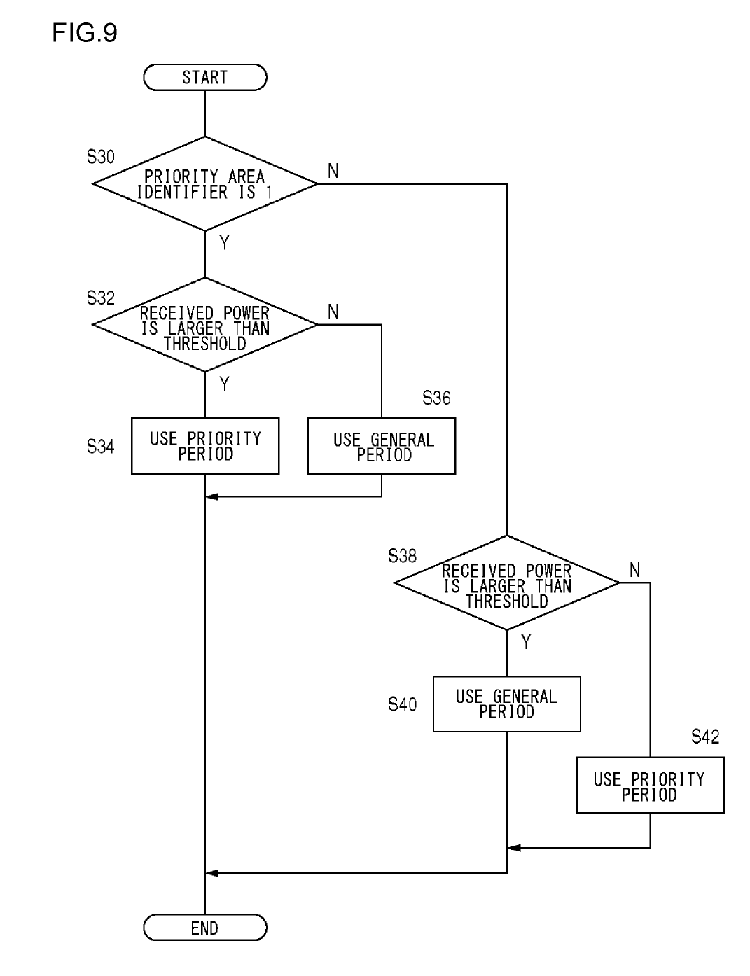

FIG. 9 is a flow chart showing the procedure for selecting a priority period or a general period in the terminal apparatus 14. If the priority area identifier is “1” (Y in S30) and the received power is larger than the threshold (Y in S32), the extraction unit 66 decides in favor of the use of the priority period (S34). If the received power is not larger than the threshold (N in S32), the extraction unit 66 decides in favor of the use of the general period (S36). If the priority area identifier is not “1” (N in S30) and the received power is larger than the threshold (Y in S38), the extraction unit 66 decides in favor of the use of the general period (S40). If the received power is not larger than the threshold (N in S38), the extraction unit 66 decides in favor of the use of the priority period (S42).

A modification of the present invention will be described. In the modification of the present invention, a vehicle present in the first area is a vehicle present close to an intersection and thus, a packet signal from the terminal apparatus of the vehicle is important information from the viewpoint of suppressing a collision. Corresponding to such area definitions, a period (hereinafter, called a “inter-vehicle transmission period”) for inter-vehicle communication is formed by time-division multiplexing of a priority period and a general period. The priority period is a period to be used by a terminal apparatus present in the first area and the terminal apparatus transmits a packet signal in one of a plurality of slots forming the priority period. The general period is a period to be used by a terminal apparatus present in the second area and the terminal apparatus transmits a packet signal by the CSMA method in the general period. A terminal apparatus present outside the second area transmits a packet signal by the CSMA method regardless of the frame configuration. Here, in which area the terminal apparatus mounted on a vehicle is present is determined. Incidentally, some base station apparatuses have no first area formed therearound. In such a case, the inter-vehicle transmission period contains no priority period and is formed of general periods only.

That is, two types of frame configuration are defined. The base station apparatus notifies terminal apparatuses of information about the frame in use by a packet signal broadcasted in a road-to-vehicle transmission period. Because a frame containing no priority period (hereinafter, called a “first frame”) has a simpler frame configuration than a frame containing a priority period (hereinafter, called a “second frame”), reducing the information amount of control information. To simplify the configuration of control information, the base station apparatus according to the present modification includes information about the road-to-vehicle transmission period in a packet signal when the first frame is used and includes, in addition to information about the road-to-vehicle transmission period, information about the priority period in a packet signal when the second frame is used.

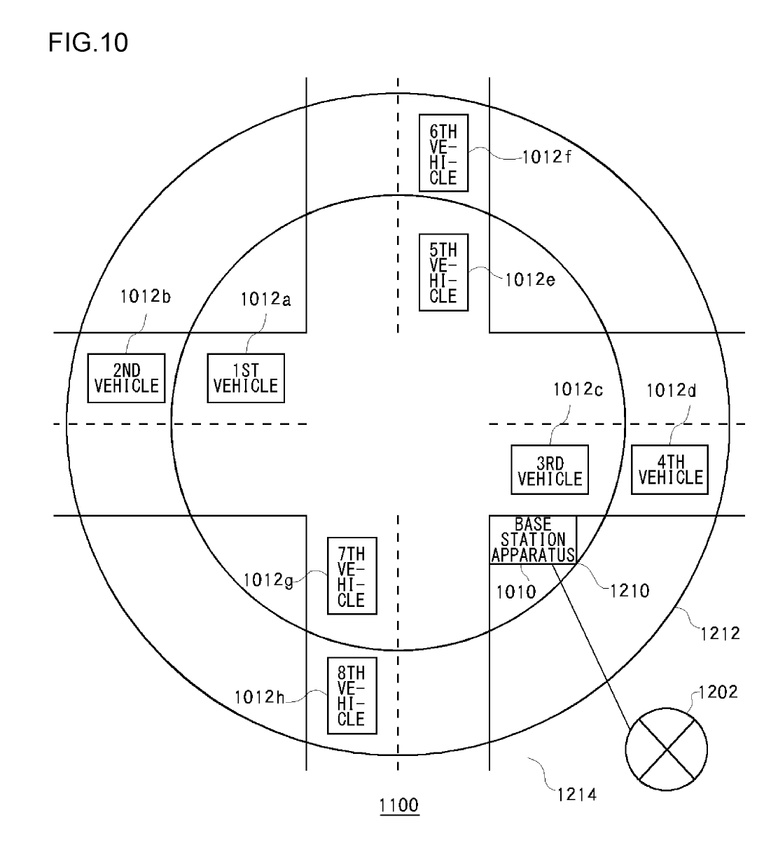

FIG. 10 shows the configuration of a communication system 1100 according to a modification of the present invention. This corresponds to a case when one intersection is seen from above. The communication system 1100 includes a base station apparatus 1010, a first vehicle 1012a, a second vehicle 1012b, a third vehicle 1012c, a fourth vehicle 1012d, a fifth vehicle 1012e, a sixth vehicle 1012f, a seventh vehicle 1012g, and an eighth vehicle 1012h, which are collectively referred to as vehicles 1012, and a network 1202. The base station apparatus 1010 of the communication system 1100, the vehicles 1012, the network 1202, a first area 1210, a second area 1212, and an area outside second area 1214 correspond to the base station apparatus 10 of the communication system 100, the vehicles 12, the network 202, the first area 210, the second area 212, and the area outside second area 214 shown in FIG. 1, so that the description thereof is herein omitted.

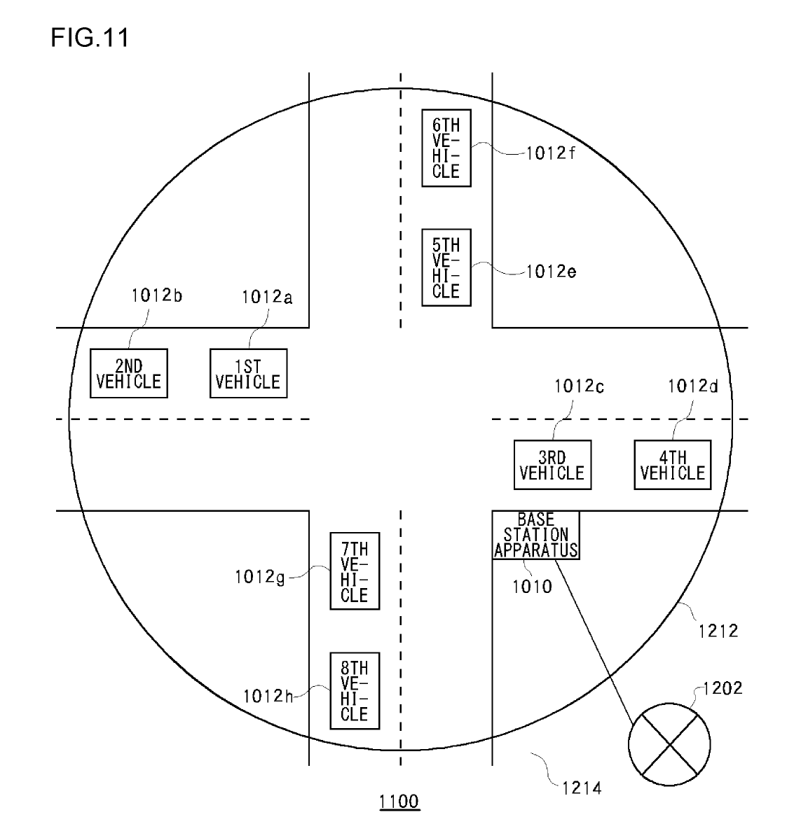

FIG. 11 is a diagram showing another configuration of the communication system 1100 according to the modification of the present invention. The communication system 1100 in FIG. 11 is configured in the same manner as in FIG. 10, but the first area 1210 is not formed. For example, an intersection assumed for FIG. 11 is considered to be different from an intersection assumed for FIG. 10. In FIG. 11, the inter-vehicle transmission period contains no priority period and is formed of general periods only. In such a case, a control packet signal as a packet signal from the base station apparatus 1010 is not needed and only an RSU packet signal is broadcasted. Also, the extension part is not needed as control information and only the basic part is contained. That is, when the first frame as shown in FIG. 11 is used, compared with a case when the second frame as shown in FIG. 10 is used, a portion of a plurality of packet signals broadcasted in the road-to-vehicle transmission period is broadcasted and a portion of control signals is contained in the packet signals. Whether to use the base station apparatus 1010 shown in FIG. 10 the base station apparatus 1010 shown in FIG. 11 to use is set by the operator.

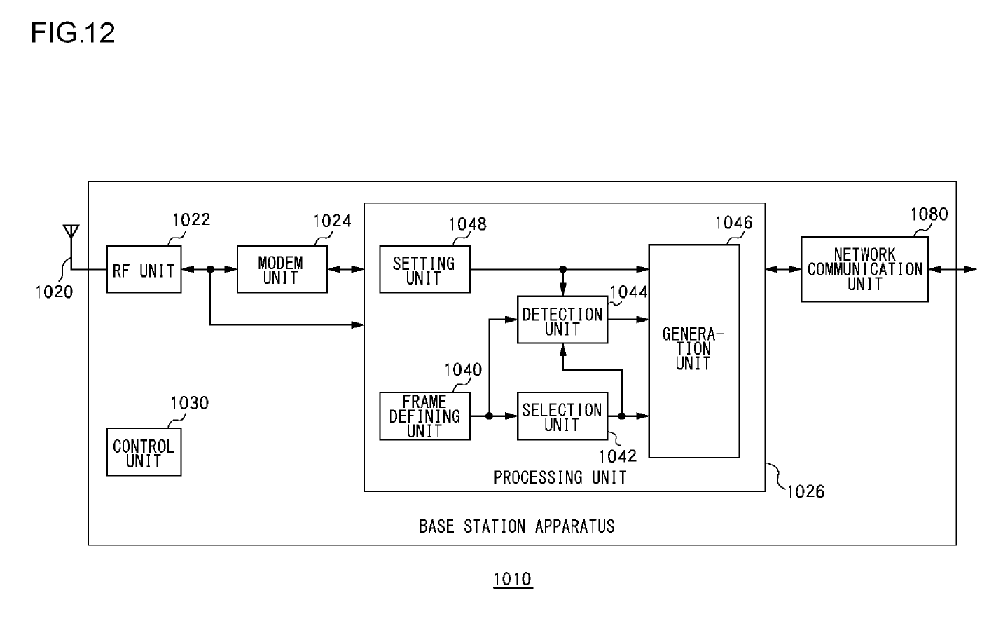

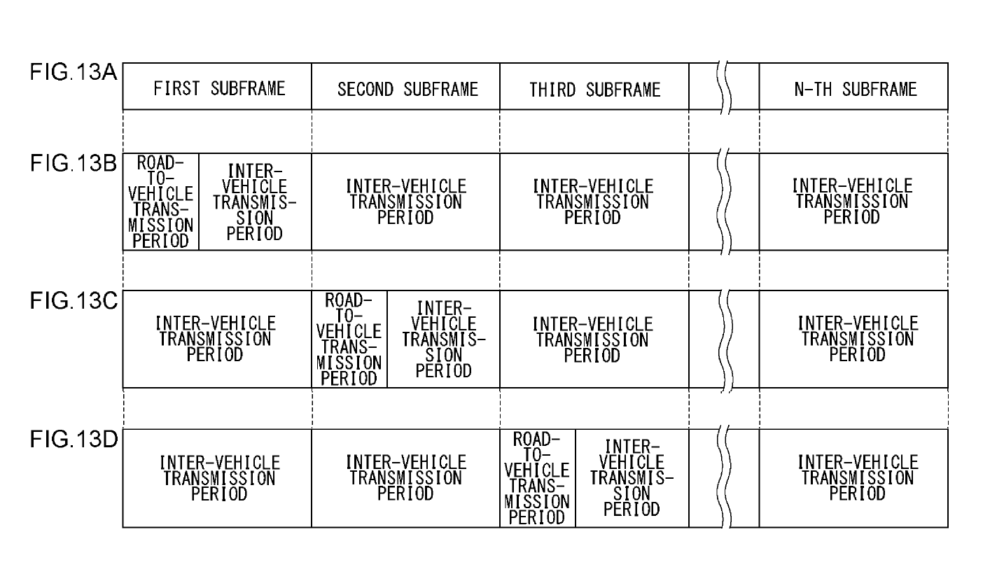

FIG. 12 shows the configuration of the base station apparatus 1010. The base station apparatus 1010 includes an antenna 1020, an RF unit 1022, a modem unit 1024, a processing unit 1026, a control unit 1030, and a network communication unit 1080. The processing unit 1026 includes a frame defining unit 1040, a selection unit 1042, a detection unit 1044, a generation unit 1046, and a setting unit 1048. The antenna 1020, the RF unit 1022, the modem unit 1024, the processing unit 1026, the control unit 1030, the network communication unit 1080, the frame defining unit 1040, the selection unit 1042, the detection unit 1044, the generation unit 1046, and the setting unit 1048 of the base station apparatus 1010 correspond to the antenna 20, the RF unit 22, the modem unit 24, the processing unit 26, the control unit 30, the network communication unit 80, the frame defining unit 40, the selection unit 42, the detection unit 44, the generation unit 46, and the setting unit 48 of the base station apparatus 10 in FIG. 2. The description herein focuses on differences. FIGS. 13A to 13D show the format of the frame defined for the communication system 1100. FIGS. 13A to 13D are similar to FIGS. 3A to 3D, so that the description thereof is herein omitted.

The setting unit 1048 has an interface to receive instructions from an operator and receives setting instructions of parameters via the interface. For example, the interface is a button and the setting unit 1048 receives setting instructions of parameters through input to the button. The interface may also be a connection terminal to the network communication unit 1080 described later. At this point, the setting unit 1048 receives setting instructions of parameters via the network communication unit 1080, the network 1202 (not shown), and a PC. Setting instructions of parameters concern whether to use the first frame or the second frame. The setting unit 1048 outputs the received setting instructions to the detection unit 1044 and the generation unit 1046.

The detection unit 1044 receives setting instructions from the setting unit 1048. If setting instructions concern the use of the first frame, no processing will be performed. If setting instructions concern the use of the second frame, the detection unit 1044 identifies whether each of a plurality of slots contained in the priority period is unused, in use, or collided. Before describing processing by the detection unit 1044, the configuration of a subframe in the second frame will be described.

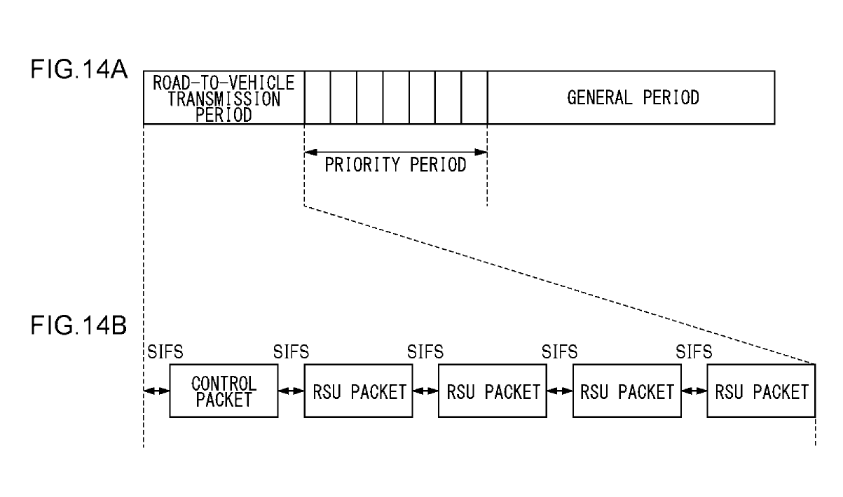

FIGS. 14A and 14B show the configuration of a subframe. This corresponds to a subframe defined for the base station apparatus 1010 in FIG. 10, that is, a subframe when the second frame is used. As shown in FIGS. 14A and 14B, one subframe is configured in the order of the road-to-vehicle transmission period, priority period, and general period. The base station apparatus 1010 broadcasts a packet signal in the road-to-vehicle transmission period, the priority period is formed by time-division multiplexing of a plurality of slots and a terminal apparatus 1014 can broadcast a packet signal in each slot, and the general period has a predetermined length and in which the terminal apparatus 1014 can broadcast a packet signal. The priority period and the general period correspond to the inter-vehicle transmission period in FIG. 13B and the like. If the subframe contains no road-to-vehicle transmission period, the subframe is configured in the order of the priority period and general period. In this case, the road-to-vehicle transmission period is also a priority period. The general period may also be formed by time-division multiplexing of a plurality of slots. The description of FIG. 14B is omitted.

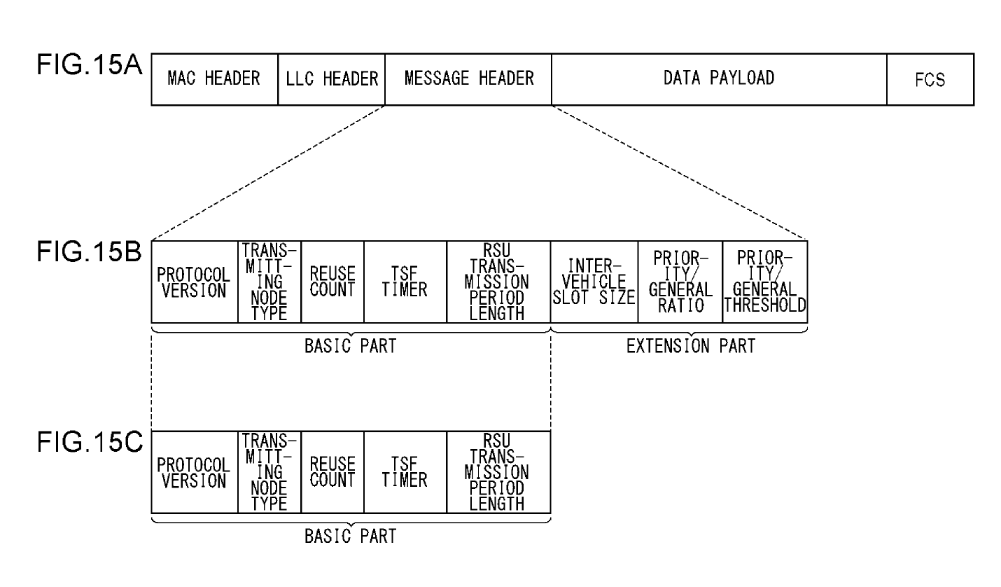

FIGS. 15A to 15C show the format of the MAC frame defined for the communication system 1100 and stored in a packet signal. The description of FIG. 15A is omitted. FIG. 15B is a diagram showing the configuration of a message header generated by the generation unit 1046 when the second frame is used. The message header contains the basic part and the extension part. The control packet signal and the RSU packet signal have, as described above, the same configuration and thus, the basic part and the extension part are contained in both of the control packet signal and the RSU packet signal broadcasted when the second frame is used. The basic part contain the “protocol version”, “transmitting node type”, “reuse count”, “TSF timer”, and “RSU transmission period length” and the extension part contains the “inter-vehicle slot size”, “priority/general ratio”, and “priority/general threshold”.

The protocol version shows the version of the corresponding protocol and also contains identification that only the basic part is contained in the message header or the basic part and the extension part are contained in the message header. The former corresponds to FIG. 15C and the latter corresponds to FIG. 15B. The identifier of the former is “0” and the identifier of the latter is “1”. The transmitting node type shows the transmission source of a packet signal containing the MAC frame. For example, “0” indicates a terminal apparatus and “1” indicates the base station apparatus 1010. If the selection unit 1042 extracts demodulation results of the other base station apparatuses 1010 from input demodulation results, the selection unit 1042 uses the value of the transmitting node type.

The reuse count shows an indicator of validity when the message header is transferred to terminal apparatuses and the TSF timer shows the transmission time. The RSU transmission period length shows the length of a road-to-vehicle transmission period and is information relating to the road-to-vehicle transmission period. The inter-vehicle slot size shows the size of a slot contained in the priority period, the priority/general ratio shows the ratio of the priority period to the general period, and the priority/general threshold is a threshold to cause the terminal apparatus 1014 to select the use of the priority period or the use of the general period and also a threshold for received power. That is, the extension part corresponds to information relating to the priority period and the general period. FIG. 15C will be described later. FIG. 12 is referred to again.

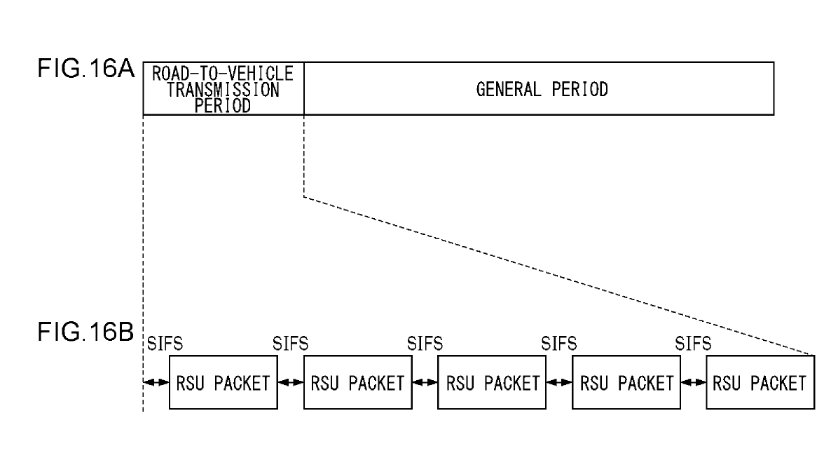

Next, a case when setting instructions concern the use of the first frame will be described. The generation unit 1046 sets a road-to-vehicle transmission period to the subframe of the received subframe number and generates RSU packet signals to be broadcasted in the road-to-vehicle transmission period. No control packet signal is generated. FIGS. 16A and 16B show another configuration of a subframe. FIG. 16A corresponds to a subframe defined for the base station apparatus 1010 in FIG. 11, that is, a subframe when the second frame is used. As shown in FIG. 16A, one subframe is configured in the order of the road-to-vehicle transmission period and general period. FIG. 16B shows the arrangement of packet signals in the road-to-vehicle transmission period. As shown in FIG. 16B, a plurality of RSU packet signals are placed in the road-to-vehicle transmission period and no control packet is placed. Previous and subsequent packet signals are separated by SIFS (Short Interframe Space). FIG. 12 is referred to again.

FIG. 15C shows the configuration of the message header when the first frame is used. As shown in FIG. 15C, the generation unit 1046 generates the basic part without generating the extension part. Information contained in the basic part is the same regardless of whether the frame is the first frame or the second frame. FIG. 12 is referred to again. In summary, the generation unit 1046 includes the basic part in RSU packet signals when the first frame is used.

The processing unit 1026 causes the modem unit 1024 and the RF unit 1022 to transmit packet signals by broadcasting in the road-to-vehicle transmission period. That is, the processing unit 1026 causes transmission of RSU packet signals containing the basic part by broadcasting in the base station broadcasting period when the first frame is used and broadcasts control packet signals and RSU packet signals containing the basic part and the extension part in the base station broadcasting period when the second frame is used. The control unit 1030 controls processing of the whole base station apparatus 1010.

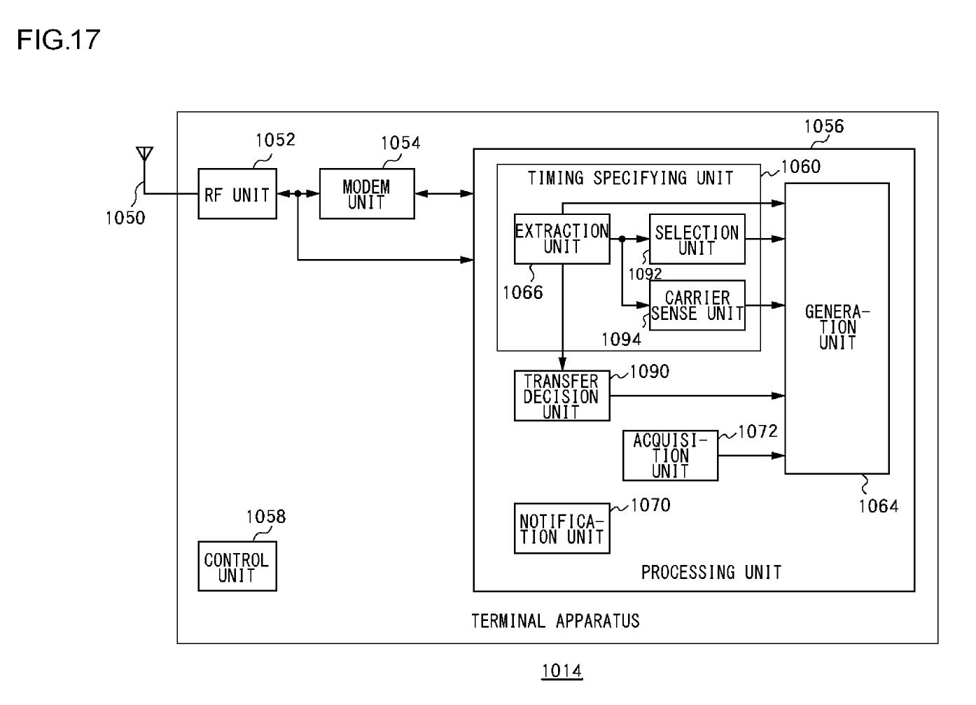

FIG. 17 shows the configuration of the terminal apparatus 1014 mounted on the vehicle 1012. The terminal apparatus 1014 includes an antenna 1050, an RF unit 1052, a modem unit 1054, a processing unit 1056, and a control unit 1058. The processing unit 1056 includes a generation unit 1064, a timing specifying unit 1060, a transfer decision unit 1090, a notification unit 1070, and an acquisition unit 1072. The timing specifying unit 1060 includes an extraction unit 1066, a selection unit 1092, and a carrier sense unit 1094. The antenna 1050, the RF unit 1052, and the modem unit 1054 perform processing similar to processing of the antenna 1020, the RF unit 1022, and the modem unit 1024 in FIG. 12. Thus, the description herein focuses on differences.

The modem unit 1054 and the processing unit 1056 receive packet signals from the other terminal apparatuses 1014 and the base station apparatus 1010 (not shown). As described above, the modem unit 1054 and the processing unit 1056 receive packet signals from the base station apparatus 1010 in the road-to-vehicle transmission period. As described above, the modem unit 1054 and the processing unit 1056 receive packet signals from the other terminal apparatuses 1014 in the general period when the first frame is used and receive packet signals from the other terminal apparatuses 1014 in the priority period and the general period when the second frame is used.

If a demodulation result from the modem unit 1054 is a packet signal from the base station apparatus 1010 (not shown), the extraction unit 1066 identifies the timing of the subframe in which the road-to-vehicle transmission period is arranged. The extraction unit 1066 generates a frame based on the subframe timing and content of the basic part in the message header of the packet signal, more specifically, content of the RSU transmission period length. The frame may be generated in the same manner as the frame defining unit 1040, so that the description thereof is herein omitted. As a result, the extraction unit 1066 generates a frame synchronized with a frame generated by the base station apparatus 1010.

The extraction unit 1066 recognizes the use of the second frame when reception of control packet signals and RSU packet signals in the road-to-vehicle transmission period or inclusion of the basic part and the extension part in the message header of the received packet signal is detected. On the other hand, the extraction unit 1066 recognizes the use of the first frame when reception of only RSU packet signals in the road-to-vehicle transmission period or inclusion of only the basic part in the message header of the received packet signal is detected.

If the use of the second frame is recognized, the extraction unit 1066 measures received power of a packet signal from the base station apparatus 1010. Based on the measured received power, the extraction unit 1066 estimates to be present in the first area 1210, the second area 1212, or the area outside second area 1214. For example, the extraction unit 1066 stores an area judgment threshold. The area judgment threshold corresponds to the above priority/general threshold. If the received power is larger than the area judgment threshold, the extraction unit 1066 decides to be present in the first area 1210. If the received power is equal to or smaller than the area judgment threshold, the extraction unit 1066 decides to be present in the second area 1212. If no packet signal from the base station apparatus 1010 is received, the extraction unit 1066 decides to be present the area outside second area 1214. Instead of the received power, the extraction unit 1066 may use the error rate or a combination of the received power and the error rate.

Based on the estimation result, the extraction unit 1066 decides in favor of one of the priority period, general period, and timing independent of the frame configuration as the transmission time. More specifically, if the extraction unit 1066 estimates to be in the area outside second area 1214, the extraction unit 1066 selects timing independent of the frame configuration. If the extraction unit 1066 estimates to be in the second area 1212 or detects the use of the first frame, the extraction unit 1066 selects a general period. If the extraction unit 1066 estimates to be in the first area 1210, the extraction unit 1066 selects a priority period. If the extraction unit 1066 selects a priority area, the extraction unit 1066 outputs detection results contained in the payload of a control packet signal to the selection unit 1092. If the extraction unit 1066 selects a general area, the extraction unit 1066 outputs the timing of the frame and subframes and information about the inter-vehicle transmission period to the carrier sense unit 1094. If the extraction unit 1066 selects timing independent of the frame configuration, the extraction unit 1066 instructs the carrier sense unit 1094 to perform a carrier sense.

The selection unit 1092, the carrier sense unit 1094, the acquisition unit 1072, the transfer decision unit 1090, the generation unit 1064, the notification unit 1070, and the control unit 1058 corresponds to the selection unit 92, the carrier sense unit 94, the acquisition unit 72, the transfer decision unit 90, the generation unit 64 in FIG. 7. The description thereof is herein omitted.

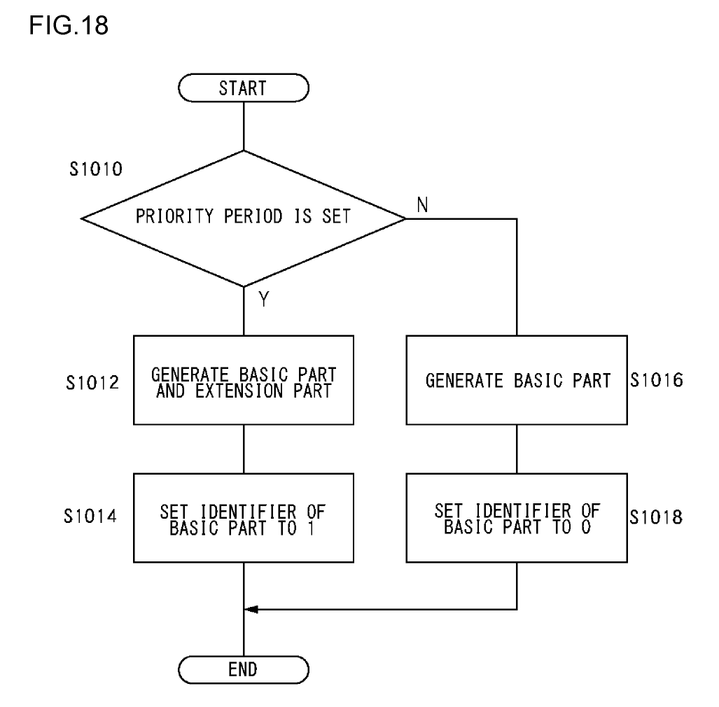

The operation of the communication system 1100 in the above configuration will be described. FIG. 18 is a flow chart showing the procedure for generating a message header in the base station apparatus 1010. If any priority period is set by the setting unit 1048 (Y in S1010), the generation unit 1046 generates the basic part and the extension part (S1012). The generation unit 1046 sets the identifier of the basic part to “1” (S1014). On the other hand, if no priority period is set by the setting unit 1048 (N in S1010), the generation unit 1046 generates only the basic part (S1016). The generation unit 1046 sets the identifier of the basic part to “0” (S1018).

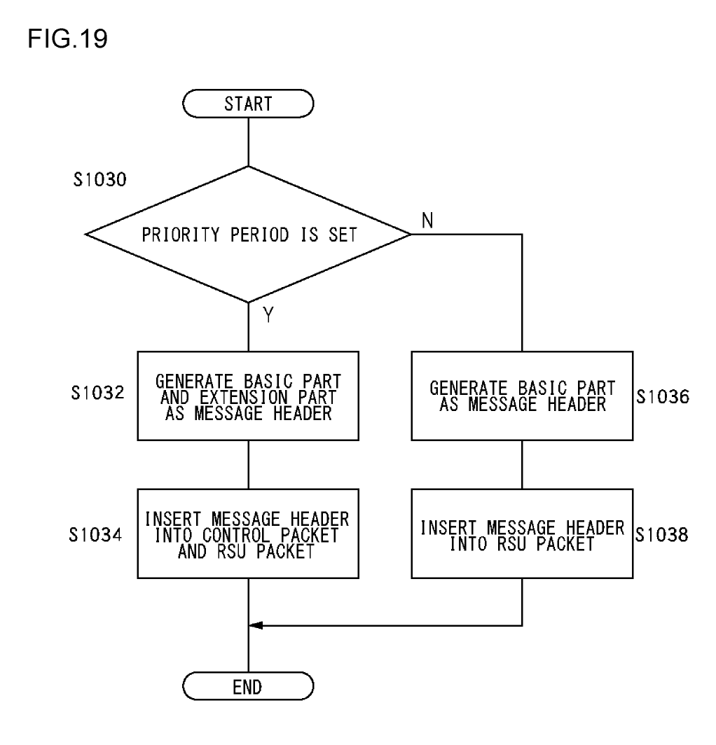

FIG. 19 is a flow chart showing the procedure for inserting the message header in the base station apparatus 1010. If any priority period is set by the setting unit 1048 (Y in S1030), the generation unit 1046 generates the basic part and the extension part as the message header (S1032). The generation unit 1046 inserts the generated message header into control packet signals and RSU packet signals (S1034). On the other hand, if no priority period is set by the setting unit 1048 (N in S1030), the generation unit 1046 generates only the basic part (S1036). The generation unit 1046 inserts the generated message header into RSU packet signals (S1038).

Next, another modification of the present invention will be described. Like the modification, the other modification also relates to a communication system used in ITS. In the modification, the message header formed of the basic part is stored in RSU packet signals when the first frame is used and the message header formed of the basic part and the extension part is stored in control packet signals and RSU packet signals when the second frame is used. The other modification seeks to improve transmission efficiency when the second frame is used. In the other modification, the message header formed of the basic part and the extension part is stored only in control packet signals when the second frame is used. The communication system according to the other modification is the same type as shown in FIGS. 10 and 11, the base station apparatus 1010 is the same type as shown in FIG. 12, and the terminal apparatus 1014 is the same type as shown in FIG. 17. The description herein focuses on differences.

The generation unit 1046 generates RSU packet signals to be broadcasted in the base station broadcasting period when the first frame is used and control packet signals and RSU packet signals to be broadcasted in the base station broadcasting period when the second frame is used. The generation unit 1046 includes the basic part in the message header of RSU packet signals to be broadcasted when the first frame is used and the basic part and the extension part in the message header of control packet signals to be broadcasted when the second frame is used. The generation unit 1046 does not include any message header in RSU packet signals to be broadcasted when the second frame is used. Incidentally, the generation unit 1046 may include only the basic part in the message header of RSU packet signals to be broadcasted when the second frame is used.

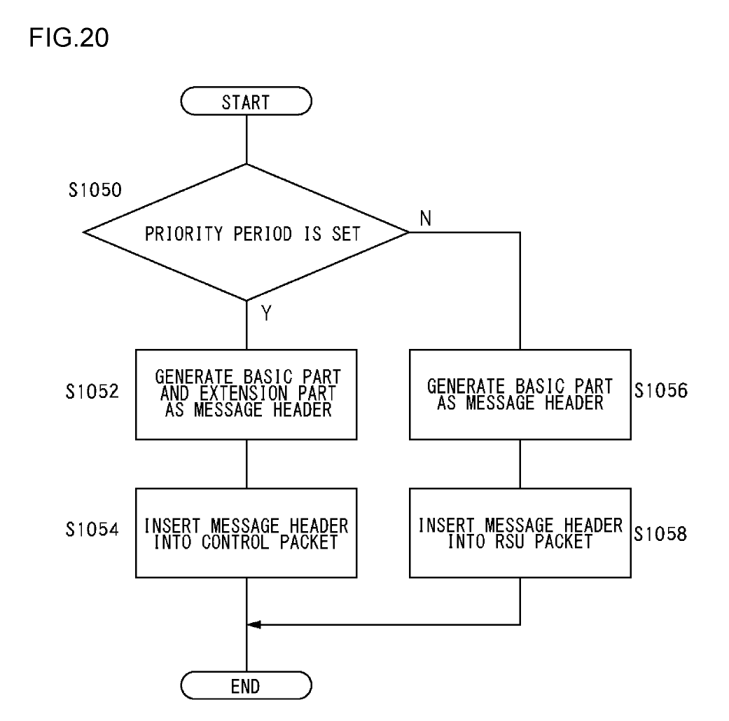

FIG. 20 is a flow chart showing the procedure for inserting the message header in the base station apparatus 1010 according to the other modification of the present invention. If any priority period is set by the setting unit 1048 (Y in S1050), the generation unit 1046 generates the basic part and the extension part as the message header (S1052). The generation unit 1046 inserts the generated message header into control packet signals (S1054). On the other hand, if no priority period is set by the setting unit 1048 (N in S1050), the generation unit 1046 generates only the basic part (S1056). The generation unit 1046 inserts the generated message header into RSU packet signals (S1058).

Next, still another modification of the present invention will be described. The frame defining unit 1040 in FIG. 12 defines a plurality of types of frames, FIG. 14A shows the second frame, and FIG. 16A shows the first frame. In the still other modification, various frame formats defined for the frame defining unit 1040 will be described. The communication system 1100 according to still the other modification is the same type as shown in FIGS. 10 and 11, the base station apparatus 1010 is the same type as shown in FIG. 12, and the terminal apparatus 1014 is the same type as shown in FIG. 17. The description herein focuses on differences.

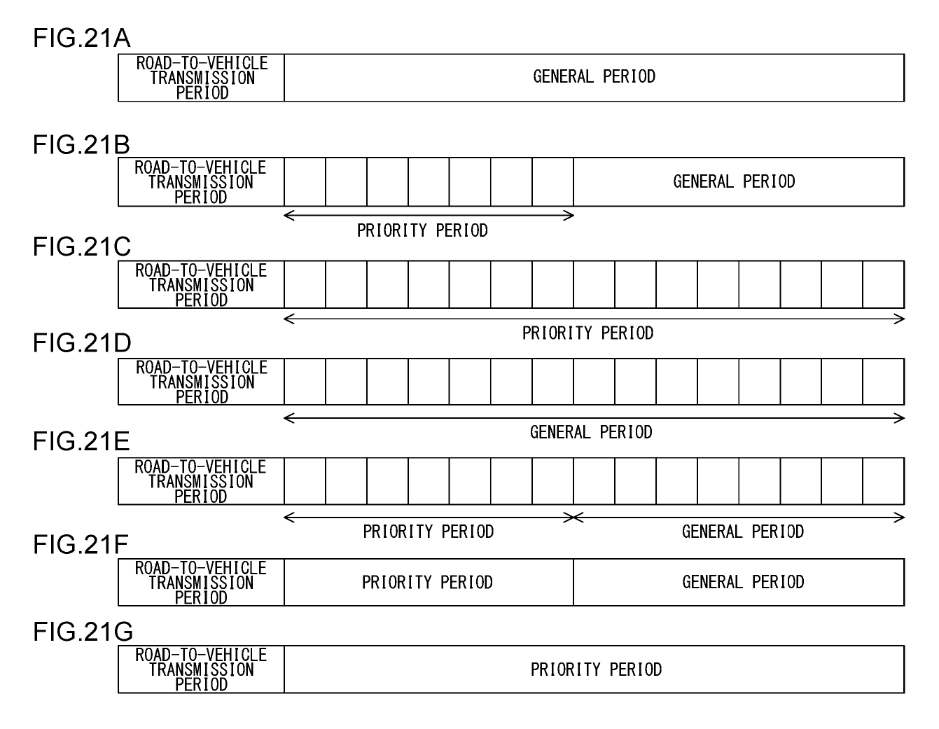

FIGS. 21A to 21G show the format of the frame defined for the communication system according to still the other modification of the present invention. FIG. 21A corresponds to the first frame shown in FIG. 16A and FIG. 21B corresponds to the second frame shown in FIG. 14A. FIG. 21C shows a frame (hereinafter, called a “third frame”) in which the base station broadcasting period and the priority period are time-multiplexed. Like the priority period in FIG. 21B, the priority period is formed from a plurality of slots. On the other hand, the priority period in FIG. 21C is longer than the priority period in FIG. 21B. That is, the number of slots contained in the priority period in FIG. 21C is larger than the number of slots contained in the priority period in FIG. 21B. If the number dividing the frame, “N” described above is fixed, the subframe length of FIGS. 21A to 21C is fixed. That is, three formats of FIGS. 21A to 21C are defined while the subframe length is maintained.

Corresponding to these definitions, whether to use the first frame, the second frame, or the third frame is input into the setting unit 1048 in FIG. 12 as setting instructions of parameter. Further, when the second frame is used, the length of the priority period, that is, information of the number of slots contained in the priority period may be input into the setting unit 1048. Thus, when the second frame is used, the length of the priority period is variable. Thus, the length of the priority period of the second frame set to “0” corresponds to the first frame and the length of the priority period of the second frame set to “maximum value” corresponds to the third frame. The generation unit 1046 also generates the message header shown in FIG. 15B when the third frame is used. In this case, the “priority/general ratio” is set to the maximum value.

FIG. 21D shows, like FIG. 21A, the first frame, but the general period is formed from a plurality of slots. Thus, as described above, FIG. 21D is a modification of FIG. 21A. When FIG. 21D is used, the detection unit 1044 does not perform any detection operation of vacant slots. In this case, the carrier sense unit 1094 in FIG. 17 may randomly select the slot. FIG. 21E shows, like FIG. 21B, the second frame, but the general period is formed from a plurality of slots. That is, the general period in FIG. 21B is formed in the same way as the general period in FIG. 21D.

FIG. 21F shows, like FIG. 21B, the second frame, but the priority period is not formed from a plurality of slots. In this case, like the carrier sense unit 1094, the selection unit 1092 in FIG. 17 performs a carrier sense in the priority period. When such formats are used, the generation unit 1046 sets the “priority/general threshold” in FIG. 15B in such a way that the area that should use the priority period, for example, the first area 1210 becomes narrower. More specifically, the “priority/general threshold” is increased. As a result, the number of the terminal apparatuses 1014 present in the first area 1210 decreases and the probability of collision of packet signals broadcasted therefrom is reduced. FIG. 21G shows, like FIG. 21C, the third frame, but the priority period is not formed from a plurality of slots. To use the priority period, like in FIG. 21F, the generation unit 1046 sets the “priority/general threshold”.

According to an embodiment of the present invention, a terminal apparatus present in the first area around the base station apparatus can broadcast a packet signal in a general period and a terminal apparatus present in the second area surrounding the first area can broadcast a packet signal in a priority period and thus, a higher priority can be attached to communication in the second area. If a higher priority can be attached to communication in the second area, the probability of a packet signal broadcasted from a terminal apparatus present in the second area being received can be increased. Moreover, because the probability of a packet signal broadcasted from a terminal apparatus present in the second area being received is increased, important data can preferentially be transmitted. The first arrangement and the second arrangement can be switched and thus, attaching a higher priority to communication in the first area and attaching a higher priority to communication in the second area can be switched. Because attaching a higher priority to communication in the first area and attaching a higher priority to communication in the second area is switched, an area to be prioritized can be selected in accordance with the intersection. Moreover, the selection of the first arrangement or the second arrangement is indicated by the priority area identifier and thus, processing can be made simpler.

Because received power is used to distinguish between the first area and the second area, the range in which the transmission loss is within certain limits can be defined as the first area. Because the range in which the transmission loss is within certain limits can be defined as the first area, a central portion of an intersection can be used as the first area. Moreover, the priority period is time-division multiplexed by slots and thus, the error rate can be reduced. In addition, CSMA/CA is executed in a general period and thus, the number of terminal apparatuses can flexibly be adjusted.

Because subframes used by other base station apparatuses are identified based on not only packet signals directly received from the other base station apparatuses, but also packet signals received from other terminal apparatuses, the precision with which subframes being used are identified can be improved. Because the precision with which subframes being used are identified is improved, the probability of collisions between packet signals transmitted from the base station apparatuses can be reduced. Because the probability of collisions between packet signals transmitted from the base station apparatuses is reduced, the terminal apparatus can recognize control information correctly. Because control information is recognized correctly, the road-to-vehicle transmission period can be recognized correctly. Because the road-to-vehicle transmission period is recognized correctly, the probability of collision of packet signals can be reduced.

Because subframes excluding subframes in use are preferentially used, the possibility of transmitting a packet signal in overlapping timing with a packet from another base station apparatus can be reduced. Because a subframe with lower received power is selected when all subframes are used by other base station apparatuses, an influence of interference of packet signals can be limited. Because received power of a terminal apparatus is used as received power from another base station apparatus to be the source of control information relayed by the terminal apparatus, estimation processing of the received power can be simplified.

Because the basic part is generated when the first frame is used and the basic part and the extension part are generated when the second frame is used, the message header in accordance with the frame configuration can be generated. Because the message header in accordance with the frame configuration is generated, highly flexible vehicle-vehicle communication can be realized. Because highly flexible vehicle-vehicle communication is realized, a highly flexible terminal apparatus can be realized. Because the basic part is generated and the extension part is not generated when the first frame is used, transmission efficiency can be improved. Because the basic part and the extension part are generated when the second frame is used, necessary information can be notified. Processing can be simplified because it is only necessary to change whether to generate the extension part depending on which of the first frame and the second frame to use. Processing can be simplified because the basic part is generated regardless of whether the first frame is used or the second frame is used.

Because a packet signal contains an identifier to distinguish between inclusion of only the basic part in the packet signal and inclusion of the basic part and the extension part in the packet signal, whether the extension part is included can reliably be notified. Also because a packet signal contains an identifier to distinguish between inclusion of only the basic part in the packet signal and inclusion of the basic part and the extension part in the packet signal, the inclusion of the extension part can easily be notified. Because the extension part can include the size of a slot contained in the priority period, the ratio of the priority period to the general period, and a threshold to cause a terminal apparatus to select the use of the priority period or the use of the general period, information necessary for operation can be notified.

Because the basic part and the extension part are included in control packet signals and RSU packet signals, the receiving probability of the basic part and the extension part can be improved. Because the probability of receiving the basic part and the extension part is improved, processing by a terminal apparatus can be made correct. Because the basic part is included in RSU packet signals broadcasted when the first frame is used and the basic part and the extension part are included in control packet signals and RSU packet signals broadcasted when the second frame is used, the receiving probability can be improved while degradation in transmission efficiency being limited. Because the basic part is contained in RSU packet signals broadcasted when the first frame is used and the basic part and the extension part are contained in control packet signals broadcasted when the second frame is used, the receiving probability can be improved while transmission efficiency being improved. Because frames of a plurality of types of formats can be used, various communication conditions can be tackled. Because the length of the priority period can be adjusted, various communication conditions can be tackled.

Because received power is used to distinguish between the first area and the second area, the range in which the transmission loss is within certain limits can be defined as the first area. Because the range in which the transmission loss is within certain limits can be defined as the first area, a central portion of an intersection can be used as the first area. Moreover, the priority period is time-division multiplexed by slots and thus, the error rate can be reduced. In addition, CSMA/CA is executed in a general period and thus, the number of terminal apparatuses can flexibly be adjusted.

Because subframes used by other base station apparatuses are identified based on not only packet signals directly received from the other base station apparatuses, but also packet signals received from other terminal apparatuses, the precision with which subframes being used are identified can be improved. Because the precision with which subframes being used are identified is improved, the probability of collisions between packet signals transmitted from the base station apparatuses can be reduced. Because the probability of collisions between packet signals transmitted from the base station apparatuses is reduced, the terminal apparatus can recognize control information correctly. Because control information is recognized correctly, the road-to-vehicle transmission period can be recognized correctly. Because the road-to-vehicle transmission period is recognized correctly, the probability of collision of packet signals can be reduced.

Because subframes excluding subframes in use are preferentially used, the possibility of transmitting a packet signal in overlapping timing with a packet from another base station apparatus can be reduced. Because a subframe with lower received power is selected when all subframes are used by other base station apparatuses, an influence of interference of packet signals can be limited. Because received power of a terminal apparatus is used as received power from another base station apparatus to be the source of control information relayed by the terminal apparatus, estimation processing of the received power can be simplified.

The present invention has been described above based on an embodiment. The embodiment is illustrative only and one skilled in the art may comprehend that various modifications of combination of the components and the processes are possible and such modifications are also included within the scope of the present invention.

The present embodiment may be characterized by the following items:

### (Item 1)

A base station apparatus controlling inter-terminal communication, including a generation unit configured to generate information about a frame in which a first period, a second period, and a third period are time-multiplexed and a broadcasting unit configured to broadcast a packet signal containing the information generated by the generation unit in the first period, wherein a terminal apparatus present in a first area around the base station apparatus can broadcast the packet signal in the third period indicated by the information generated by the generation unit and the terminal apparatus present in a second area surrounding the first area can broadcast the packet signal in the second period.

According to the item, importance can be set in accordance with the position from which a packet signal should be transmitted.

### (Item 2)

The base station apparatus according to item 1, wherein the generation unit includes an identifier in the information and uses one of a first arrangement in which the terminal apparatus present in the first area around the base station apparatus can broadcast the packet signal in the third period and the terminal apparatus present in the second area surrounding the first area can broadcast the packet signal in the second period and a second arrangement in which the terminal apparatus present in the first area around the base station apparatus can broadcast the packet signal in the second period and the terminal apparatus present in the second area surrounding the first area can broadcast the packet signal in the third period based on the identifier.

### (Item 3)

A terminal apparatus controlling inter-terminal communication, including a communication unit configured to receive information about a frame in which a first period, a second period, and a third period are time-multiplexed in the first period from a base station apparatus and an instruction unit configured to select use of the second period or the use of the third period based on the information received by the communication unit and notifies the communication unit of broadcasting of a packet signal in the selected period, wherein the instruction unit selects the use of the third period when present in a first area around the base station apparatus and the use of the second period when present in a second area surrounding the first area.

What is claimed is:

1. A base station apparatus controlling inter-terminal communication, comprising:
a generation unit configured to generate a packet signal containing an identifier to identify that basic information of the basic information and extended information is contained in the packet signal or the basic information and the extended information are contained in the packet signal, wherein
the basic information contains information about a first period and the extended information contains the information about a second period and a third period; and
a broadcasting unit configured to broadcast the packet signal containing the identifier generated by the generation unit.

2. The base station apparatus according to claim. 1, wherein
the generation unit generates the basic information containing the information about the first period when a first frame in which the first period and the third period are time-multiplexed is used and generates the extended information containing the information about the second period and the third period, in addition to the basic information, when a second frame in which, in addition to the first period and the third period, the second period is time-multiplexed, is used and
the broadcasting unit broadcasts the packet signal containing the basic information generated by the generation unit in the first period when the first frame is used and broadcasts the packet signal containing the basic information and the extended information in the first period when the second frame is used.

3. The base station apparatus according to claim 1, wherein
the generation unit generates the basic information containing the information about the first period and the extended information containing the information about the second period and the third period of a frame in which the first period, the second period, and the third period are time-multiplexed and
the broadcasting unit broadcasts the packet signal containing the basic information and the extended information in the first period.

4. The base station apparatus according to claim 1, wherein
the generation unit includes a size of a slot contained in the second period, a ratio of the second period to the third period, or a threshold to cause a terminal apparatus to select use of the second period or the use of the third period in the extended information.

5. The base station apparatus according to claim 1, wherein
the generation unit generates the basic information containing the information about the first period and the extended information containing the information about the second period and the third period of a frame in which the first period, the second period, and the third period are time-multiplexed,
the broadcasting unit broadcasts a first type of packet signal containing a first type of data and a second type of packet signal containing a second type of data that is different from the first type of data in the first period, and the basic information and the extended information are contained in the first type of packet signal and the second type of packet signal.

6. The base station apparatus according to claim. 1, wherein
the generation unit generates the basic information containing the information about the first period when a first frame in which the first period and the third period are time-multiplexed is used and generates the extended information containing the information about the second period and the third period, in addition to the basic information, when a second frame in which, in addition to the first period and the third period, the second period is time-multiplexed, is used and
the broadcasting unit broadcasts a first type of packet signal containing a first type of data in the first period when the first frame is used and broadcasts a second type of packet signal containing a second type of data that is different from the first type of data in the first period, in addition to the first type of packet signal, when the second frame is used,
wherein
the basic information is contained in the first type of packet signal broadcasted by the broadcasting unit when the first frame is used and the basic information and the extended information are contained in the first type of packet signal and the second type of packet signal broadcasted by the broadcasting unit when the second frame is used.

7. The base station apparatus according to claim. 1, wherein
the generation unit generates the basic information containing the information about the first period when a first frame in which the first period and the third period are time-multiplexed is used and generates the extended information containing the information about the second period and the third period, in addition to the basic information, when a second frame in which, in addition to the first period and the third period, the second period is time-multiplexed, is used and
the broadcasting unit broadcasts a first type of packet signal containing a first type of data in the first period when the first frame is used and broadcasts a second type of packet signal containing a second type of data that is different from the first type of data in the first period, in addition to the first type of packet signal, when the second frame is used,
wherein
the basic information is contained in the first type of packet signal broadcasted by the broadcasting unit when the first frame is used and the basic information and the extended information are contained in the second type of packet signal broadcasted by the broadcasting unit when the second frame is used.

8. The base station apparatus according to claim 1, wherein
the generation unit generates the information about a frame when one of a first frame, a second frame, and a third frame is used, wherein the first period and the third period are time-multiplexed in the first frame, the first period, the second period, and the third period are time-multiplexed in the second frame, and the first period and the second period are time multiplexed in the third frame and
the broadcasting unit broadcasts the packet signal containing the information generated by the generation unit in the first period.

9. The base station apparatus according to claim 8, wherein
when the second frame is used by the generation unit, a length of the second period is variable.
